(19) United States
(12) Patent Application Publication
(10) Pub. No.: US 2015/0210336 A1
(43) Pub. Date: Jul. 30, 2015

(54) Motorcycle Suspension Accessory Device

(71) Applicant: Kirt Gardiner, Kent, WA (US)

(72) Inventor: Kirt Gardiner, Kent, WA (US)

(21) Appl. No.: 14/554,237

(22) Filed: Nov. 26, 2014

Related U.S. Application Data
(60) Provisional application No. 61/931,775, filed on Jan. 27, 2014.

(51) Int. Cl. B62J 99/00

(52) U.S. Cl. CPC B62J 99/00; B62J 2099/0086

(57) ABSTRACT

A motorcycle suspension accessory device is provided that updates the look of a typical motorcycle front suspension system by providing exposed faux springs that affix over the functional fork tubes of the suspension. The device comprises an upper bridge element, a lower bridge element, and a pair of coil springs disposed therebetween. The forks of the motorcycle suspension are received through aligned apertures in the upper and lower bridge elements, while the springs are disposed between the apertures and receive the forks therethrough. The springs include an inner diameter sized to receive the forks without interference, while also providing a spring rate that minimizes structural loads on the triple trees. At the same time, the springs prevent movement of the bridge elements relative to the triple trees when installed. Spring perches are optionally provided at each aperture to support the ends of the springs.

### CROSS REFERENCE TO RELATED APPLICATION

This application claims the benefit of U.S. Provisional Application No. 61/931,775 filed on Jan. 27, 2014. The above identified patent application is herein incorporated by reference in its entirety to provide continuity of disclosure.

### BACKGROUND OF THE INVENTION

1. Field of the Invention

The present invention relates to motorcycle suspension devices and devices that improve or alter the appearance of a motorbike. More specifically, the present invention relates to a novelty accessory for a motorcycle in which a pair of faux spring elements can be installed and supported between the triple clamps of a motorcycle front suspension to update the appearance and style of the front forks.

Many motorcyclists enjoy customizing and personalizing their motorcycles. Various accessories are available that can be installed or fitted onto a motorcycle to update its style, change its appearance, or improve its performance. Many of these accessories are stylistic, including tassels and other novelties, chrome parts, carbon fiber parts and the like. Others are more performance orientated, and include items such as updated handlebars, foot pegs, updated mirrors, and other functional elements. While motorcycle accessories can range in price and can quickly become expensive options, many motorcyclists pride themselves on having a unique and personalized ride that is distinguished from models delivered from the factory.

The present invention is related to a novelty accessory that updates the look of the front suspension of a motorcycle. Most front suspension systems comprise a pair of fork tubes that are secured in a parallel arrangement using an upper and lower fork tree, or triple tree. The triple tree rotatably secures the fork tubes to the frame of the motorcycle, while the lower ends of the forks secure to the front wheel using a front axle. The fork tubes support the suspension springs and dampers internally within walled tubes, whereby the spring is not visible and the damper piston moves in and out of the fork tube.

While front forks are functional and highly sophisticated components, they lack an external look or flashiness that accompanies the rear suspension, which generally includes one or more exposed springs coiled over one or more dampers. The present invention contemplates a novelty accessory item that updates the look of the front suspension to provide this exposed spring look to the front of the motorcycle.

Specifically, the present invention contemplates a novelty accessory that updates the look of the front suspension by placing faux springs over the fork tubes. The device comprises an assembly having an upper and lower bridge element configured to be secured over a set of parallel fork tubes between the upper and lower triple tree. The bridge elements include a length and a first and second fork tube aperture, whereby the bridge elements align in parallel with each other and support a first and second spring element therebetween. The spring elements are placed over the existing fork tubes and between the bridge elements along the exterior of the fork tubes. The spring is never loaded because the triple trees are statically arranged, therefore the exterior spring elements provide a purely decorative update to the front suspension once installed.

2. Description of the Prior Art

Devices have been disclosed in the prior art that relate to motorcycle and bicycle suspensions. These include devices that have been patented and published in patent application publications. The following is a list of devices deemed most relevant to the present disclosure, which are herein described for the purposes of highlighting and differentiating the unique aspects of the present invention, and further highlighting the drawbacks existing in the prior art.

Devices of the prior art relate largely to functional suspension elements. These include devices to improve suspension performance, those devices that change the geometry of the suspension (extensions, shims, etc.), and those that add additional functional features or configurability to the suspension system. The present invention, by contrast, is a faux suspension article that updates the ornamental aspects of the vehicle without interfering or compromising the existing suspension components, their geometry, or their existing design.

Specifically, the present invention is configured to secure over a first and second suspension fork tube of a motorcycle front suspension and support a first and second exposed spring element between an upper and lower bridge element. the bridge elements span between the two fork tubes and secure thereto between the upper and lower triple tree of the existing suspension. In this way, the look of the front suspension is updated to an exposed spring “look,” adding personality and updating the style of the motorbike without compromising performance.

Devices in the art provide functional elements or require changes in the geometry of the existing suspension, which is strictly against the teachings of the present invention. Notable devices in the art include U.S. Pat. No. 7,073,807 to Masui, which comprises a bicycle suspension fork assembly that supports a light source thereon. Other devices include U.S. Pat. No. 3,643,974 to Peate, U.S. Pat. No. 5,992,870 to LaRiviere, and U.S. Pat. No. 5,813,685 also to LaRiviere, which disclose extension kits for bicycles that allow the front forks to extend outward for an updated front suspension appearance and geometry.

These prior art devices update the geometry of the vehicle suspension or enhance its performance. The present invention is related to a novelty device that enhances only the look and style of the device, providing novelty and usefulness in the form of personalization and improved aesthetics. Overall, the present invention substantially diverges in design elements from the prior art. Consequently it is clear that there is a need in the art for an improvement to existing motorcycle personalization devices. In this regard the instant invention substantially fulfills these needs.

### SUMMARY OF THE INVENTION

In view of the foregoing disadvantages inherent in the known types of motorcycle accessories now present in the prior art, the present invention provides a new motorcycle suspension accessory that is utilized for updating the appearance and style of the fork tubes of the front suspension.

It is therefore an object of the present invention to provide a new and improved motorcycle accessory device that has all of the advantages of the prior art and none of the disadvantages.

It is another object of the present invention to provide a motorcycle accessory device that is configured to be positioned between the upper triple tree and the lower triple tree of the motorcycle front suspension and be disposed over a pair of aligned suspension fork tubes without interfering with the operation of the suspension.

Another object of the present invention is to provide a motorcycle accessory device that comprises a pair of coil springs disposed between bridge members, whereby the bridge members and the springs are configured to accept a pair of fork tubes therethrough.

Yet another object of the present invention is to provide a motorcycle accessory device that updates the fork tube appearance of a motorcycle front suspension such that the front suspension appears to have an exposed set of coil springs disposed about the fork tubes once the device is installed.

Another object of the present invention is to provide a motorcycle accessory device that provides a faux set of springs that are not designed to be loaded or compressed when installed, and furthermore are designed with a minimal spring rate that the distance between the bridge elements can fluctuate with minimal load applied by the spring if compressed.

Another object of the present invention is to provide a motorcycle accessory that does not move relative to the suspension once installed, thereby eliminating any vibration source.

A final object of the present invention is to provide a motorcycle accessory device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the accessory device of the present invention.

FIG. 2 shows an exploded view of the accessory device and the typical front suspension of a motorcycle.

FIG. 3 shows the accessory device installed on a typical motorcycle front suspension.

FIG. 4 shows the accessory device installed on another motorcycle.

### DETAILED DESCRIPTION OF THE INVENTION

Reference is made herein to the attached drawings. Like reference numerals are used throughout the drawings to depict like or similar elements of the motorcycle accessory device of the present invention. For the purposes of presenting a brief and clear description of the present invention, the preferred embodiment will be discussed as used for providing an update to the style and look of the front suspension, whereby the device coordinates with existing suspension elements without interfering with the same once installed. The figures are intended for representative purposes only and should not be considered to be limiting in any respect.

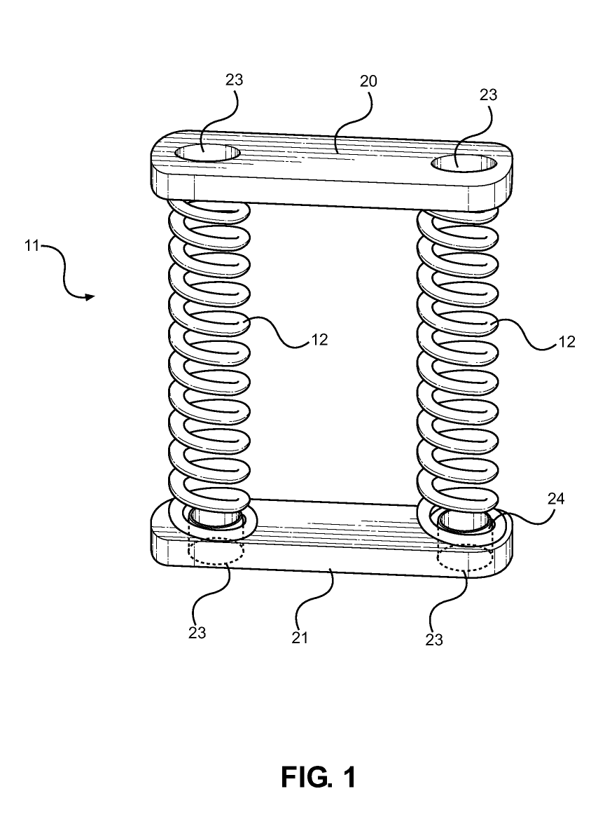

Referring now to FIG. 1, there is shown a perspective view of the motorcycle suspension accessory device 11 of the present invention. The device 11 comprises a non-functional suspension article that is specifically configured to secure over a traditional front suspension arrangement of a motorcycle and provide a unique change of appearance therefor. Specifically, the assembly changes the look of the suspension such that it appears to observers that the front fork tubes of the suspension support exposed coil springs, as opposed to internal springs as are traditionally found on most motorcycle front suspension systems.

The device itself is a faux suspension article that comprises an upper bridge element 20 and a lower bridge element 21 separated by a given distance and connected by a pair of coil springs 12 therebetween. The bridge elements 20, 21 comprise elongated plate members having a length, a thickness, and a depth, whereby the role of the bridge elements 20, 21 is to support the spring elements 12 between the triple trees of the motorcycle suspension. The length of the bridge elements is defined as the distance between the ends thereof, which is a dimension measured in parallel to the separation of the spring elements 12. The depth is the fore-aft distance, and the thickness is defined as a dimension measured in parallel to the coil spring axial directions (that direction which would compress the springs axially).

The bridge elements 20, 21 include a first and second fork tube aperture 23 extending through the thickness thereof. The apertures 23 are sized to accept a fork tube of a motorcycle front suspension, whereby the fork tube is inserted through the aperture 23 in the lower bridge element 21, routed through the interior of the coil spring 12 thereabove, and finally through the correspondingly aligned aperture 23 in the upper bridge element 23. Therefore, the aligned apertures 23 between the upper 20 and lower 21 bridge element are design and configured to support a fork tube therethrough. The length of the bridge elements therefore is sized to such an extent that the bridge elements can span the distance between the fork tubes of the motorcycle and provide a suitably located aperture for each tube such that modification of the existing suspension is avoided and the assembly simply slides over the exposed fork tubes in their original position.

The coil springs 12 are spring elements having a spring rate, a free length, and an inner diameter. The inner diameter is sized to receive a fork tube of a motorcycle without interference and without contact therewith. The inner diameter of the springs 12 forms an open cylindrical volume within the spring interior that receives the fork tubes therein. This allows the fork tube to slide through the apertures 23 of each bridge element 20, 21 and through the interior of each spring 12. The free length of the spring is preferably an offset distance between the upper 20 and lower 21 bridge element that will be maintained after installation. In this way, the spring places nearly zero force on the bridge elements once installed, as the distance between the bridge elements does not change once installed between the upper and lower triple tree of the suspension.

To supplement this, the spring constant of the springs 12 is preferably minimized to the extent that any movement of the bridge elements will not generate excessive forces on the triple trees, while at the same time the bridge elements will not “float,” move, or bounce between the triple tress while the motorcycle is changing momentum. It is not desired to disclose the exact spring constant, but rather to recognize that the spring constant should allow for minor compression of the springs during installation (in the event the triple trees are closer than the free length of the springs allow) without applying significant load on the triple trees in the process. At the same time, the spring constant should be sufficient to separate the bridge elements and ensure they do not move toward each other after installation or move along the fork tubes. This is particularly critical during periods of rapid momentum shifts, such as under braking or ride over rough terrain. The bridge elements are static and pressed against the triple trees sufficiently to accommodate a balance between a static installation and one that minimizes structural loads imparted on the existing suspension assembly.

Along the interior surfaces of the bridge elements and disposed over each aperture 23 is a spring perch 24. The interior surfaces of the bridge elements are the surfaces facing each other, which include the lower surface of the upper bridge element 20, and the upper surface of the lower bridge element 21. The spring perches support the base of each spring 12 and prevent lateral movement of each spring 12 along the bridge elements. The ends of each spring include a flat coil portion that provides an outermost plane that is flat at each end, with the flat ends being parallel to one another. Therefore, the springs 12 stand vertically when positioned on a flat surface with either end placed against the flat surface. The spring perch is an element that is formed to accept the outermost coil of each end of the spring. One skilled in the art of suspension design would readily recognize a suitable configuration for the perch. Examples include elastomeric members, those with specific grooves to accept and maintain the outermost coil of the spring, flanges that retain the inner diameter of the spring, and others. The spring perch may be integral to the bridge elements, or alternatively may be a separable structure.

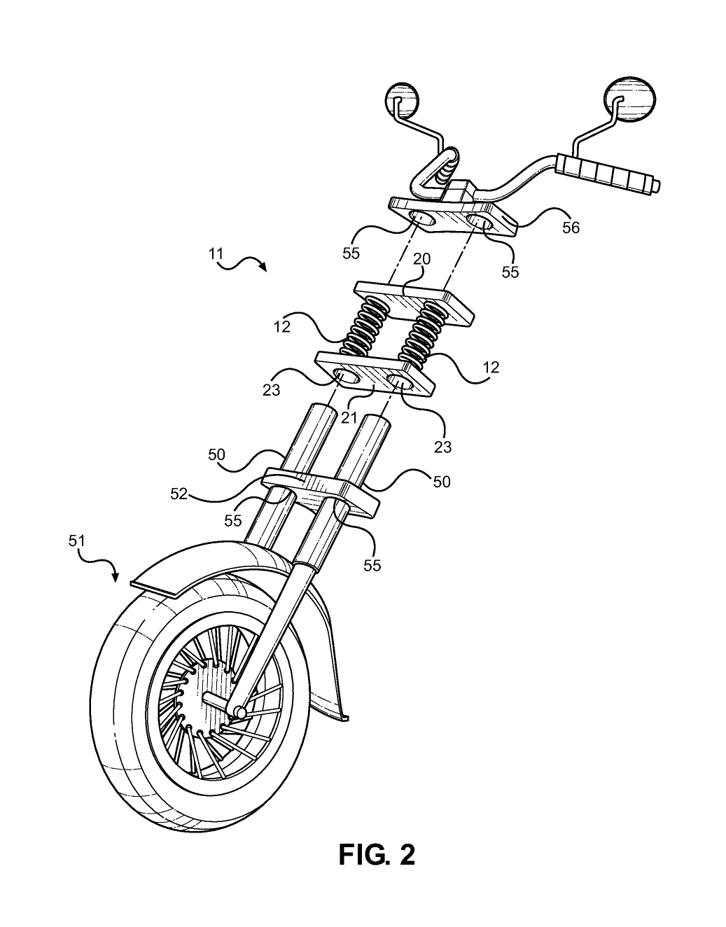

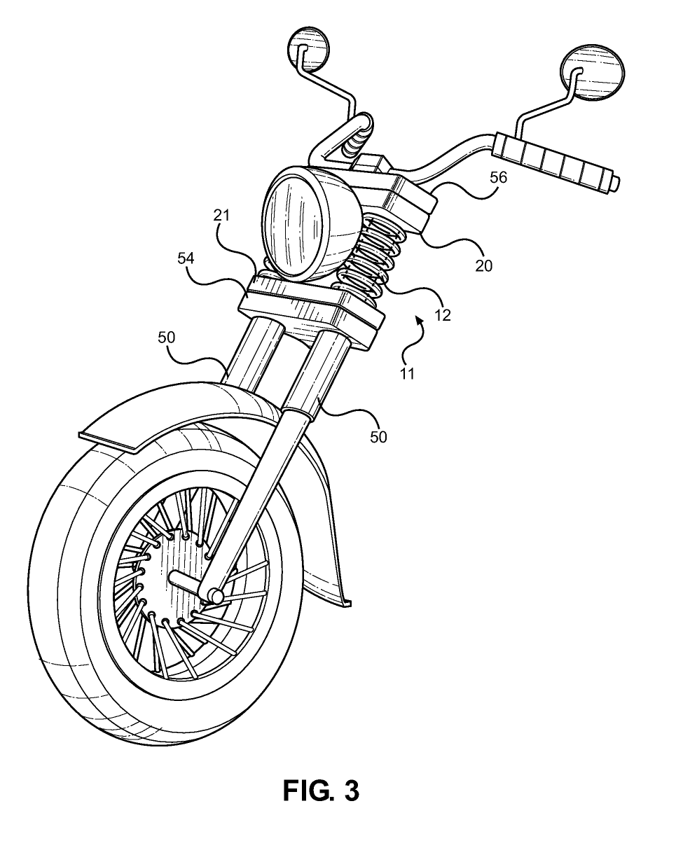

Referring now to FIGS. 2 and 3, there is shown an exploded view and an installed view of the present invention installed on a typical motorcycle front suspension assembly. The accessory device 11 of the present invention is one designed to be supported by the fork tubes 50 of the motorcycle suspension between the upper triple tree 56 and the lower triple tree 52. The triple trees 56, 52 of the suspension secure the fork tubes 50 to the frame of the motorcycle and permit the front wheel 51 to pivot therefrom. The fork tubes 50 comprise elongated members supporting the spring and damper elements of the front suspension. Generally there is a pair of suspension fork tubes 50, each being aligned and clamped to the triple trees. The triple trees comprise a pair of apertures 55 therethrough that accept the fork tubes 50 and clamp the same.

The present invention is designed to be statically positioned between the upper triple tree 56 and the lower triple tree 52 of the suspension, and accept the fork tubes 50 therethrough. To install the accessory device 11, the upper triple tree 52 is removed from the suspension, and the device 11 is placed over the exposed fork tubes. If necessary, the lower bridge member 21 is installed, and thereafter the springs 12, and finally the upper bridge member 20. The forks 50 are positioned through the apertures 23 in the bridge elements and through the inner diameters of the spring elements 12. Once the device 11 is installed, the upper triple tree 56 is installed. The lower bridge element 21 abuts against the lower triple tree 54, and the upper bridge element 20 abuts against the upper triple tree 56.

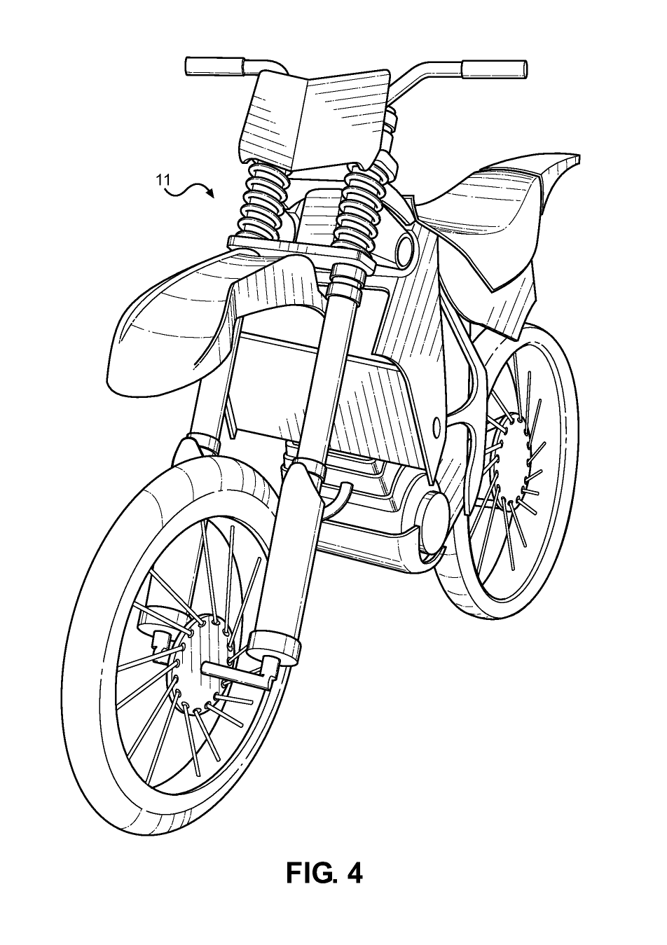

Referring now to FIG. 4, there is shown a view of the accessory device 11 installed on a motorcycle. The device is installed between the triple trees, and can be installed on any motorcycle with a front suspension configuration comprises a pair of fork tubes and a pair of triple trees. Once installed, the device 11 provides an outer appearance of a front suspension with exposed springs. The device 11 therefore provides a faux suspension component, which is configured to update the look of the motorcycle. The present invention provides a unique, retro appearance reminiscent of motorcycles produced in the 1930s and 1940s, which included springer forks disposed on the front forks. Thus, the device disclosed provides motorcyclists with an inexpensive accessory that can be used to customize motorcycles.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A motorcycle suspension accessory, comprising:
an upper bridge element, a lower bridge element, a first coil spring, and a second coil spring therebetween;
said upper bridge element having a first aperture and a second aperture extending in parallel therethrough;
said lower bridge element having a first aperture and a second aperture extending in parallel therethrough;
said first aperture of said upper bridge element aligning with the first aperture of said lower bridge element;
said second aperture of said upper bridge element aligning with the second aperture of said lower bridge element;
said first coil spring extending between said first aperture of said upper bridge element and said first aperture of said lower bridge element;
said second coil spring extending between said second aperture of said upper bridge element and said second aperture of said lower bridge element;
said first apertures and said second apertures of said upper bridge element and said second bridge element each sized to receive a motorcycle fork tube therethrough;
said first coil spring and said second coil spring having an open inner diameter;
said inner diameter sized to receive a motorcycle fork tube therethrough;
said upper bridge element, said lower bridge element, said first coil spring, and said second coil spring configured to be supported by a pair of fork tubes on motorcycle between an upper triple tree and a lower triple tree.

2. The motorcycle suspension accessory of claim 1, wherein:
said first coil spring and said second coil spring having ends comprising a flat coil;
a spring perch element supporting the flat coil of each end of said first coil spring and said second coil spring.

3. The motorcycle suspension accessory of claim 1, wherein:
said first coil spring and said second coil spring have a spring rate that resists movement of said upper bridge element and said lower bridge element while minimizing load imparted on said upper triple tree and said lower triple tree.
